(19) United States
(12) Patent Application Publication
(10) Pub. No.: US 2006/0159087 A1
(43) Pub. Date: Jul. 20, 2006

(54) Method for identifying personal information on a network

(76) Inventor: Katsuyasu Ono, Tokyo (JP)

Correspondence Address: Ralph A. Dowell of DOWELL & DOWELL P.C., 2111 Eisenhower Ave, Suite 406, Alexandria, VA, 22314, US

(21) Appl. No.: 11/312,657

(22) Filed: Dec. 21, 2005

Related U.S. Application Data
(63) Continuation of application No. PCT/JP04/08724, filed on Jun. 21, 2004.

(30) Foreign Application Priority Data
Jun. 21, 2003 (JP) 2003-202085

(51) Int. Cl. H04L 12/56

(52) U.S. Cl. 370/389

(57) ABSTRACT

The present invention provides a method by which to obtain a MAC address of a communication party remotely across a router. In a network where an originating host and a destination host belong to different local areas, the originating host (10) transmits a request packet by which the originating host requests the destination host to send a GUID (Global Unique Identifier) of the destination host. In response to the request packet, the destination host (30) sends back a response packet in which the destination host has its own GUID contained therein. The originating host (10) acquires a GUID of destination host from the response packet. The originating host inquires of a database (62) that stores GUIDs and personal information in an associated manner, about the personal information associated with the acquired GUID.

### RELATED APPLICATIONS

This application is a continuation of PCT application no. PCT/JP2004/008724, filed Jun. 21, 2004, which claims priority from JP application no. 2003-202085, filed Jun. 21, 2003.

### TECHNICAL FIELD

The present invention relates to the techniques by which to identify personal information on the communication parties on the network such as the Internet, intranet and extranet.

### BACKGROUND TECHNOLOGY

The Internet operates on the basic rule of anonymity, and therefore the idea of identifying individuals is scarce. However, as a result of the explosive increase in the number of users of the Internet, there are now many adverse effects evident on account of this anonymity. Such adverse effects include virus mail or spam mail for instance. Today, when the Internet is much used in the world of business, anonymity can rather be an obstacle.

Conceivable as techniques for identifying the personal information on the other parties to the communication on the Internet are a method in which BIOSs or CPUs are given their own IDs and a method in which global IP addresses are utilized.

### SUMMARY

Problems to be Solved

However, giving BIOSs or CPUs their own IDs requires much labor and is not realistic. Since global IP addresses are assigned to LANs, the computers, for which private addresses are assigned within a LAN, cannot be identified by the use of the global IP addresses.

The present invention has been made in view of the foregoing circumstances and an object thereof is to provide a technology for identifying personal information on the other parties to the communication on a network.

Means for Solving the Problems

One embodiment according to the present invention relates to a method for identifying personal information in a network where an originating host and a destination host belong to different local areas. This method includes the steps of: transmitting a request packet in which an originating host requests a destination host to send a GUID (Global Unique Identifier) of the destination host when the originating host and the destination host belong to different networks beyond a router; sending back, in response to the request packet, a response packet, in which the destination host has its own GUID contained therein, to the originating host via the router; and acquiring, by the originating host, a GUID of the destination host from the response packet. According to this method, the GUID of a destination host can be acquired from a remote across a router.

In an arbitrary place on a network there may be provided a personal information database which stores GUIDs and personal information in an associated manner. In this case, the originating host's inquiring of the personal information database for the personal information associated with the GUID acquired from the response packet makes it possible for the originating host to identify personal information of the destination host. In an arbitrary place on the network there may be provided a billing database which stores personal information and charge information in a manner that associates them. In this case, the method may further include the step of storing, by the originating host, access to the originating host from the destination host or charge information that serves as compensation for service provided to the destination host from the originating host and personal information on the destination host in a manner such that the access or the charge information is associated with the personal information on the destination host using the GUID acquired from the response packet. This makes it possible to charge for the connections to the origination host. “Service provided to the destination host from the originating host” includes a startup of software or a reference to data stored in the originating host, the use of a specific function and the like. Charging may be done in units of access or the length of time.

The personal information database and the billing database may be provided in a local originating host or local area. It is preferred, however, that only one each be provide in the network. If they are provided in a network, the communication of inquiries about personal information or billing be encrypted. If a plurality of personal databases and billing databases are to be set up, synchronism among the databases may be established

Another embodiment according to the present invention relates to a network interface apparatus. This apparatus includes: a transmitting unit which transmits a request packet with which to request a destination host belonging to a different network across a router to transmit a GUID of the destination host, when packets are exchanged with the destination host; a receiving unit which receives via the router a response packet that contains the GUID of the destination host, in response to the request packet; and an acquisition unit which acquires the GUID of the destination host from the response packet. According to this, the GUID of a destination host can be acquired from a remote across a router.

Still another embodiment according to the present invention is a host terminal which comprises: the aforementioned network interface apparatus; and a personal information inquiry unit which inquires of a personal information database, provided in an arbitrary place on a network, that stores GUIDs and personal information by associating them for personal information associated with the GUIDs acquired from the response packet and thereby identifies personal information on a destination host. According to this, the personal information on a destination host can be identified based on the GUID acquired from the packet, thus improving the security.

### BRIEF DESCRIPTION OF THE DRAWINGS

FIG. 1 is a network structure diagram for explaining one embodiment of the present invention.

FIG. 2 is a function block diagram of an originating host.

### DESCRIPTION

The present invention relates to a technology for identifying personal information on the other parties to the communication on a network. In the following description, a network on which communication is held by identifying individuals is called “Biz Net” (hereinafter referred to as “BNet”); a network on which communication is held without identifying individuals, as in the past, is called “Anonymous Net” (hereinafter referred to as “ANet”); and a network added with billing information is called “Credit Net” (hereinafter referred to as “CNet”).

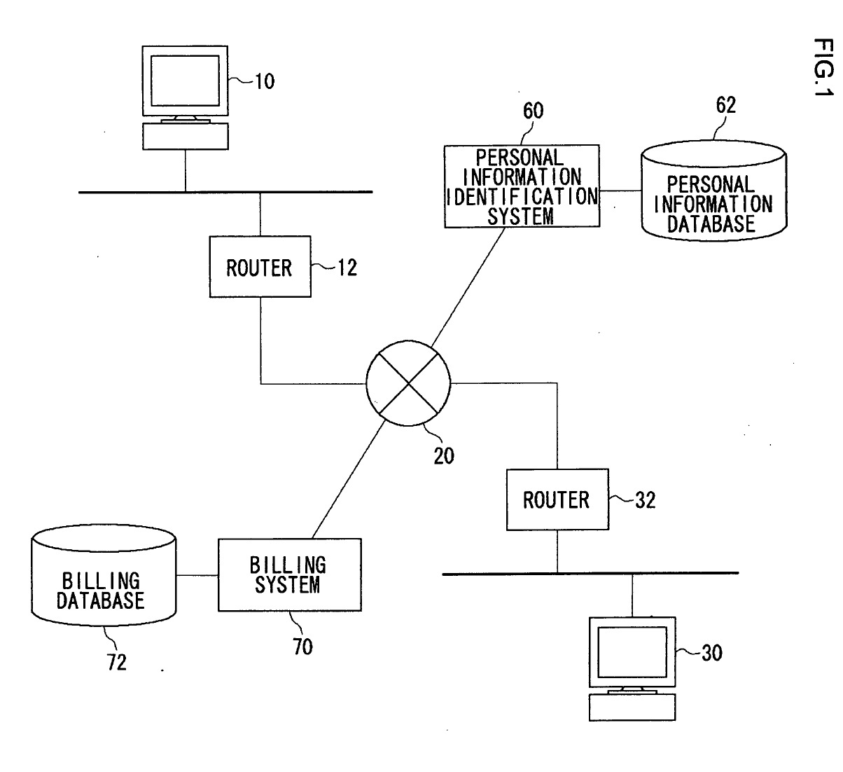

FIG. 1 is a network structure diagram for explaining an embodiment of the present invention. In the figure, a computer 10 and a computer 30 belong to different local areas. The computer 10 is connected to a network 20 via a router 12, and the computer 30 is connected to the network 20 via a router 32. The network 20 may be any arbitrary network, which includes the Internet, an intranet and an extranet.

According to one embodiment of the present invention, a method for finding a MAC address of the other party to the communication from a remote beyond a router is added to IP, TCP or an upper-layer protocol such as SMTP or HTTP. By this, it is possible to identify personal information of parties to all the communications on the Internet provided that a database of MAC addresses and personal information is created beforehand.

The following description is given on the assumption that the computer 10 and the computer 30 communicate with each other with packet switching done according to the TCP/IP protocol.

An IP datagram includes an IP header portion and an IP data portion. An IP address is included in the IP header portion, and a network element relaying a packet refers to the IP address within the IP header of the packet and transfers the packet to the target computer.

Between networks (between LAN and LAN), an IP datagram is transmitted according to the IP address. In contrast thereto, within a LAN, transmission takes place using the MAC addresses of the network boards provided for the respective hosts. Hence, no communication can be held here unless the correspondence relations between the IP addresses and the MAC addresses are known. Normally, a host has this correspondence table within memory, and ARP (Address Resolution Protocol) is known as the protocol necessary for creating it. Generally, the ARP is used to find a MAC address corresponding to a destination IP address within the same segment (same local area). In this manner, communication can be established between an originating host and a destination host.

The MAC address, by the way, is a unique identifier around the world. Hence, if there is a database associating MAC addresses and personal information, it is possible to identify the personal information belonging to the other parties to the communication by obtaining their MAC addresses on all the communications on the network. The present IP protocol, however, does not provide a method for identifying the MAC address of a destination host from a remote beyond the router.

In the present embodiment, the IP protocol is added with a method for finding the MAC address of a destination host from a remote beyond a router. This protocol is called “Remote ARP” in this specification. As the free number in the protocol portion of the IP header, 200, for instance, is defined as a “Remote ARP Query”, and 201 as a “Remote ARP Response”.

When the computer 10 is an originating host and the computer 30 a destination host in FIG. 1, a procedure for the originating host 10 to acquire the MAC address of the destination host 30 will be explained. It is assumed here that there is the IP communication already established between a source host 10 and a destination host 30 and the mutual IP addresses are already known.

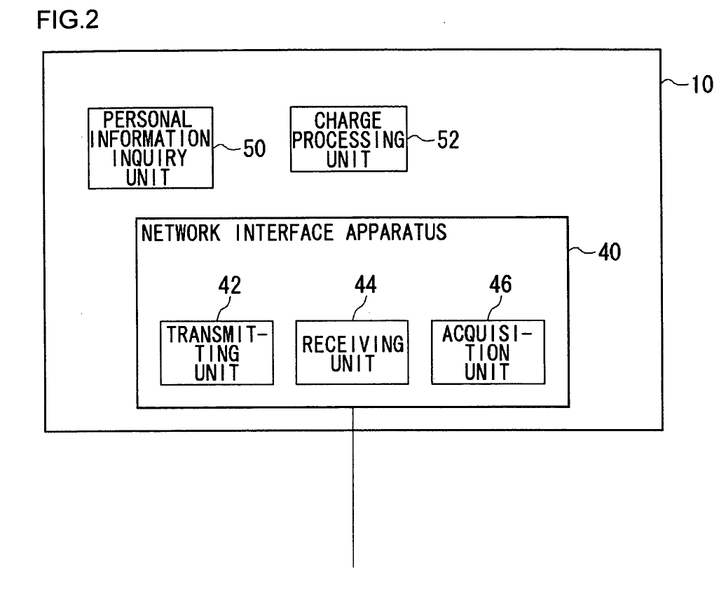

FIG. 2 is a function block diagram of portions pertinent to the present embodiment in the originating host 10. The function blocks in FIG. 2 can be realized in a variety of forms by the combination of hardware and software. The originating host 10 connects to a network via a network interface apparatus 40 such as a network card, a LAN card and a LAN board. The network interface apparatus 40 includes a transmitting unit 42, a receiving unit 44 and an acquisition unit 46.

The transmitting unit 42 in the network interface apparatus 40 transmits to the destination host 30 a Remote ARP Query packet requesting the MAC address of the said destination host. This Remote ARP Query packet includes the IP address of the destination host in its data portion. The Remote ARP Query packet is routed to reach the destination host 30. Here, for the sake of explanation, IP address information is all placed on the data portion; however, where IP address information is placed is simply a question of implementation and is therefore optional.

The destination host 30 having received the Remote ARP Query packet transmits back to the originating host 10 a Remote ARP Response packet which includes its own IP address and MAC address in the data portion. The Remote ARP Response packet reaches the originating host 10 who has sent the Remote ARP Query packet on the IP network, and the receiving unit 44 receives this packet. The acquisition unit 46 extracts the MAC address of the destination host 30 from the Remote ARP Response packet. In this manner, the originating host 10 can find the MAC address of the destination host 30.

Provided in an arbitrary location on a network are a personal information database 62 which stores MAC addresses and personal information associated with each other and a personal information identification system 60 which controls the former. A personal information inquiry unit 50 in the originating host 10 transmits the MAC address acquired from the response packet to the personal information identification system 60. The personal information identification system 60 acquires, from the personal information database 62, personal information associated with the received MAC address and sends it back to the personal information inquiry unit 50. In this manner, the originating host 10 can identify the personal information on the destination host 30. A network provided with a function to identify personal information as described above may be called a BNet.

In Ethernet (registered trademark), a MAC address is represented by a length of 48 bits. On the assumption of the presence of 10 billion computers worldwide, the amount of information for the MAC addresses of all the computers is 60 billion bytes (6*10¹⁰ bytes), and therefore a database can be sufficiently created with current technology even if they are to be associated with the personal information.

The above description is based on an assumption that both parties to an IP communication have their MAC addresses. Since it is technically possible to assign a GUID (Global Unique Identifier) to a device, such as a modem, which does not have a MAC address, a database can also be created by assigning a GUID to a device having no MAC address.

A billing database 72 which stores personal information and charge information associated with each other and a billing system 70 which controls the former may be provided in an arbitrary location on a network. The charge processing unit 52 in an originating host 10 transmits to the billing system 70 the charge information for a destination host 30 after associating it with the personal information on the destination host by a GUID. The billing system 70 has the billing database 72 store the received information. This makes it possible to charge the accesses by a destination host 30 to a source host 10 or the services provided by a source host 10 to a destination host 30. Provision of services from a source host 10 to a destination host 30 includes, for example, a startup of software or a reference to data stored in a source host 10 or use of a specific function. Charging may be done in units of access or the length of time. A network provided with a billing function as described above can be called a CNet.

Routers 12 and 22 may add routing information on a network, through which a Remote ARP packet is routed, to the Remote ARP Response packet. Since this will identify a rough address of the other party to the communication, it becomes possible to decide on permission/non-permission for access based on the local information. It is to be noted, however, that adding routing information to a packet involves a change of router and is therefore expensive. Thus, generally speaking, it is less expensive if routing information is not added.

The present invention may be applied to protocols other than IP as well. For example, if the Remote ARP of the present invention is implemented in the HTTP protocol, it is possible to identify visitors to a Web site or prevent improper users from entering a Web site. Also, if the Remote ARP is implemented in an Email protocol (e.g., SMTP or POP3), it is possible to reject the reception of spam mail or virus mail other than business mail by specifying the parties to communication.

There have been various methods conceived for charging the use of software by identifying individuals (for example, the basic principle of charging software is described in Japanese Patent Application Laid-Open No. Sho60-77218). However, they have not been put to practical use because there have not been any simple and general protocol like the present invention. According to the present invention, personal information on the other party to a communication can be identified from a GUID in the communication on a network, so that it is possible to charge a fee by identifying the personal information and application software of the user who has accessed the server.

As explained above, according to the present invention, it is possible to reject the reception of spam mail because the other party to a communication in Email can be identified. Also, because it is possible to identify an accessing party at a Web server, access to a Web site by ones other than specific accessing parties can be prevented, thus improving security. Furthermore, where some software is offered online, it is possible to charge an accessing party for the offer of the software because the accessing party can be identified. In addition to these, the personal identification method of the present invention can be applied to arbitrary business operations that have a need for the identification of individuals on a network.

The present invention is such that its implementation has no effects on existing protocols and besides only those who need it may install the present protocol, and it can be done at low cost. Moreover, it is possible to use the ANet, BNet and CNet side by side. That is, the conventional ANet may be used for transmission if anonymity is desired; the BNet may be used when, for instance, the user wants to specify mail from the other parties in business; or the CNet may be used when a software or content vendor wants to charge the fees.

The present invention has been described based on the embodiments. The embodiment is only exemplary. It is understood by those skilled in the art that various modifications to the combination of each component and process thereof are possible and that such modifications are also within the scope of the present invention.

In the embodiments above, a description has been given of the case of MAC addresses, but it is possible to use arbitrary GUIDs other than this.

While it is preferable that only one set of a personal information identification system and a personal information database is present on the network, the arrangement may be such that it is provided for every local host, in every local area or on the Internet. Also, where there are a plurality of these databases, synchronism among the databases may be established.

Though the description has been given in the embodiments above where the personal information identification system and the billing system are two different things, it is possible to integrate the two systems.

### INDUSTRIAL APPLICABILITY

According to the present invention, it is possible to identify the personal information of the other parties to a communication on a network.

What is claimed is:

1. A method for identifying personal information, including:
transmitting a request packet in which an originating host requests a destination host to send a GUID (Global Unique Identifier) of the destination host when the originating host and the destination host belong to different networks across a router;
sending back, in response to the request packet, a response packet, in which the destination host has its own GUID contained therein, to the originating host via the router; and
acquiring, by the originating host, a GUID of the destination host from the response packet.

2. A method for identifying personal information according to claim 1, wherein in an arbitrary place on a network there is provided a personal information database which stores GUIDs and personal information in an associated manner,
further including identifying personal information of the destination host at the originating host by inquiring of the personal information database for the personal information associated with the GUID acquired from the response packet.

3. A method for identifying personal information according to clam 2, wherein in an arbitrary place on the network there is provided a billing database which stores personal information and charge information in a manner that associates them,
further including storing, by the originating host, access to the originating host from the destination host or charge information that serves as compensation for service provided to the destination host from the originating host and personal information on the destination host in a manner such that the access or the charge information is associated with the personal information on the destination host using the GUID acquired from the response packet.

4. A method for identifying personal information according to claim 1, wherein the GUID is a MAC address.

5. A method for identifying personal information according to claim 2, wherein the GUID is a MAC address.

6. A method for identifying personal information according to claim 3, wherein the GUID is a MAC address.

7. A network interface apparatus, including:
a transmitting unit which transmits a request packet with which to request a destination host belonging to a different network across a router to transmit a GUID of the destination host, when packets are exchanged with the destination host;
a receiving unit which receives via the router a response packet that contains the GUID of the destination host, in response to the request packet; and
an acquisition unit which acquires the GUID of the destination host from the response packet.

8. A host terminal, comprising:
the network interface apparatus according to claim 5; and
a personal information inquiry unit which inquires of a personal information database, provided in an arbitrary place on a network, that stores GUIDs and personal information by associating them for personal information associated with the GUID acquired from the response packet and thereby identifies personal information on a destination host.

9. A host terminal according to claim 8, further comprising a charge processing unit which stores access to a host terminal from the destination host or charge information that serves as compensation for service provided to the host terminal from the destination host, in a billing database, provided in an arbitrary place on the network, that stores the personal information and the charge information by associating them, in a manner such that the access or the charge information is associated with the personal information on the destination host.
